(19) United States
(12) Patent Application Publication
(10) Pub. No.: US 2008/0193742 A1
(43) Pub. Date: Aug. 14, 2008

(54) Polyimide Film with Improved Surface Activity

(75) Inventors: Shuichi Maeda, Yamaguchi (JP); Yukinori Kohama, Yamaguchi (JP); Masahiro Naiki, Yamaguchi (JP); Tesuji Hirano, Yamaguchi (JP); Masayuki Kinouchi, Yamaguchi (JP)

Correspondence Address: Nixon Peabody, 401 9th Street, N.W., Suite 900, Washington, DC, 20004-2128, US

(73) Assignee: UBE INDUSTRIES , LTD., Ube-shi, Yamaguchi (JP)

(21) Appl. No.: 11/793,591

(22) PCT Filed: Dec. 22, 2005
(86) PCT No.: PCT/JP2005/023670

§ 371 Date: Nov. 14, 2007

(30) Foreign Application Priority Data
Dec. 22, 2004 (JP) 2004-370738

(51) Int. Cl. B32B 5/16; B05D 7/00

(52) U.S. Cl. 428/331; 428/323; 427/212

(57) ABSTRACT

A polyimide film having enhanced surface activity and improved surface adhesion, and a polyimide film having a metal film in which the metal film is bonded to the polyimide film with practically accepted high bonding strength are provided by a polyimide film having, at least on one surface, a coated particle layer comprising inorganic particles having a mean particle size of 1,000 nm or less which are coated with a metal oxide layer via an intervening layer comprising a mixture of the same metal oxide as above and polyimide, and the polyimide film having a metal film placed on the coated particle layer.

### FIELD OF THE INVENTION

The present invention relates to a polyimide film having improved surface activity. In particular, the invention relates to a polyimide film having high surface activity which is favorably employable for the manufacture of a copper clad laminate (CCL).

### BACKGROUND OF THE INVENTION

Since a polyamide film, particularly an aromatic polyimide film, is excellent in the heat resistance, mechanical characteristics, electric characteristics, environmental resistance, and flame retardant properties, and further has enough flexibility, the polyimide film is widely employed for manufacturing various electronic elements such as copper clad laminates. Especially, since a polyimide film comprising tetracarboxylic acid units selected from the group consisting of 3,3′,4,4′-biphenyltetracarboxylic acid units and a mixture of 3,3′,4,4′-biphenyltetracarboxylic acid units and pyro-mellitic acid units and diamine units of 4,4′-diaminobenzene or a mixture of 4,4′-diaminobenzene and 4,4′-diaminodiphenyl ether has particularly excellent characteristics for manufacturing electronic elements, this polyimide film is widely utilized for Manufacturing electronic elements.

The copper clad laminate is manufactured by placing a copper metal film on one surface or both surfaces of a polyimide film. The copper metal film layer can be made of a copper foil. However, since a thinner copper film layer is recently required from the viewpoints of miniaturization and performance improvement of electronic elements, at present a method of plating copper metal on a polyimide film to give a thin film layer is generally employed for the formation of the copper film layer.

It is known that the polyimide film has poor surface activity. Therefore, a copper metal film placed or plated on a polyimide film does not show enough bonding strength between the metal film and the polyimide film. Particularly, while the aforementioned polyimide film comprising tetracarboxylic acid units selected from the group consisting of 3,3′'4,4′-biphenyltetracarboxylic acid units or a mixture of 3,3′,4,4′-biphenyltetracarboxylic acid units and pyromellitic acid units and diamine units of 4,4′-diaminobenzene or a mixture of 4,4′-diaminobenzene and 4,4′-diaminodiphenyl ether has excellent characteristics for the manufacture of electronic elements, there is a problem in that it is difficult to place or plate a metal film layer on the polyimide film with enough bonding strength.

Heretofore, a copper metal foil has been fixed to a polyimide film via an epoxy adhesive or a polyimide adhesive. Otherwise, a copper metal foil is placed on a thermoplastic polyimide layer coated on the polyimide film under pressure at an elevated temperature.

On the other hand, the method of plating a metal on a polyimide film has been performed using a polyimide film having a surface on which metal oxide particles are attached or embedded.

Patent publication 1 discloses an aromatic polyimide film having a surface in which inorganic particles (mean particle size: 0.01 to 100 μm) of silica, titanium dioxide, calcium carbonate, magnesium oxide, alumina a or the like are partly embedded. It is then described that the aromatic polyimide film having the above-mentioned constituent is prepared by coating a dispersion of inorganic particles on a film of an aromatic polyamic acid (precursor of an aromatic polyimide) containing an organic solvent and then subjecting the coated film to drying and heating at an elevated temperature.

Patent publication 2 describes a flexible complex film comprising a polymer film such as a polyimide film and an insulating layer of metal oxide formed on the polyimide film. Patent publication 2 describes that the flexible complex film can be prepared by coating a modified alkyl silicate on a film surface and heating the coated film.

Patent publication 3 describes a polyimide film having a low moisture permeability which has an inorganic film produced by coating a polyimide film with a sol solution containing a metal alkoxide (including silicon alkoxide) and converting the sol into a gel.

Patent publication 4 describes a polyimide-silica hybrid film which is prepared by casting a silane-modified polyimide resin composition on a carrier film, drying the casted film, and separating the dried film from the carrier film. The silane-modified polyimide resin composition comprises a polar solvent and an alkoxy group-containing .silane-modified polyimide which is prepared by reacting a polyamic acid and/or a polyimide with an epoxy-containing alkoxysilane partial condensate. The polyimide-silica hybrid film can be converted into a polyimide film having a metal film layer by plating a metal on the hybrid film.

| | |
|---|---|
| Patent publication 1: | JP 5-25295 A |
| Patent publication 2: | JP 1-232034 A |
| Patent publication 3: | JP 4-342741 A |
| Patent publication 4: | JP 2003-136632 A |

### SUMMARY OF THE INVENTION

It is an object of the present invention to provide a polyimide film having enhanced surface activity and improved surface adhesion.

It is another object of the invention to provide a polyimide film having a metal film layer in which the metal film layer is bonded to the polyimide film with a practically acceptable high bonding strength.

It is still another object of the invention to provide a process for preparing the polyimide film having enhanced surface activity with high productivity.

In one aspect, the present invention resides in a polyimide film having, at least on one surface thereof, a coated particle layer comprising inorganic particles having a mean particle size of 1,000 nm or less which are coated with a metal oxide layer via an intervening layer comprising a mixture of the same metal oxide as above and polyimide.

In another aspect, the invention resides in a polyimide film having a metal film layer in which the metal film layer is placed on the coated particle layer of the above-mentioned polyimide film of the invention.

The intervening layer comprising a mixture of the metal oxide and polyimide (mixed metal oxide-polyimide layer) which is formed on the polyimide film can be a continuous layer or a discontinuous layer containing local discontinuous area. In the mixed metal oxide-polyimide layer, the metal oxide is contained in the form of micro particles or a composite (adduct) with polyimide.

In still another aspect, the invention resides in a process for preparing the above-mentioned polyimide film of the invention, which comprises the steps of:
coating at least one surface of a polyamic acid film containing a polar organic solvent with a dispersion comprising a metal alkoxide-containing aqueous organic solvent and inorganic particles having a mean particle size of 1,000 or less dispersed therein;
drying the coated solution to form a coated layer; and
heating the polyimide film with the coated layer to a temperature of 300° C. or higher.

The polyimide film of the invention has enhanced surface activity and improved surface adhesion, maintaining the excellent physical and chemical characteristics which are inherent to the polyimide film. Therefore, a metal film can be bonded to the polyimide film with a high bonding strength. The polyimide film of the invention can be favorably employed for the manufacture of a polyimide film having a metal film layer by plating an electro-conductive metal film such as a copper film on the polyimide film directly or via a metal layer formed by vapor deposition.

### BRIEF DESCRIPTION OF DRAWINGS

FIG. 1 is a schematic view illustrating a constitution of a polyimide film of the invention having enhanced surface activity.

FIG. 2 is a schematic view illustrating a representative constitution of a polyimide film having a metal film layer according to the invention.

In the drawings, the following notation is used:
1: polyimide film of the invention
11: polyimide substrate film
12: coated particle in which an inorganic particle is coated with a metal oxide coverage
13: coated particle layer
14: mixed metal oxide-polyimide layer
2: polyimide film having a metal film layer according to the invention
15: metal layer formed by vapor deposition
16: plated metal layer

### PREFERRED EMBODIMENTS OF THE INVENTION

The polyimide film of the invention having enhanced surface activity and the polyimide film having a metal film layer according to the invention are described below with respect to their constitutions by referring to the attached drawings.

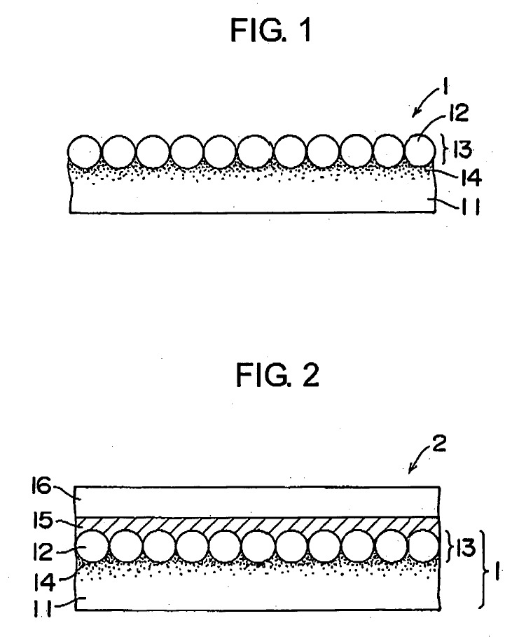

FIG. 1 is a schematic view illustrating a constitution of a polyimide film of the invention having enhanced surface activity. In FIG. 1, the polyimide film 1 of the invention comprises a polyimide substrate film 11 and a coated particle layer 13 comprising inorganic particles 12 which are coated with a metal oxide coverage, which is placed on the substrate film 11 via a mixed metal oxide-polyimide layer 14 (which comprises a mixture of the same metal oxide as above and polyimide). The mixed metal oxide-polyimide layer 14 generally is in the form of a non-uniform layer in which the concentration or density of the metal oxide is higher on the side facing the coated particle layer 13.

FIG. 2 is a schematic view illustrating a representative constitution of a polyimide film having a metal film layer according to the invention. In FIG. 2, a polyimide film having a metal film 2 according to the invention comprises a polyimide substrate film 11 and a coated particle layer 13 comprising inorganic particles 12 which are coated with a metal oxide coverage, which is placed on the substrate film 11 via an interning layer 14 comprising a mixture of the same metal oxide as above and polyimide, and a metal layer 15 formed by vapor deposition and a plated metal film 16 placed on the metal layer 15.

The preferred embodiments of the polyimide film and the polyimide film having a metal film layer according to the invention are described below.

(1) The mean particle size of the inorganic particles are 500 nm or less.

(2) The mean particle size of the inorganic particles are in the range of 3 to 500 nm.

(3) The mean particle size of the inorganic particles are in the range of 3 to 200 nm.

(4) The mean particle size of the inorganic particles are in the range of 3 to 100 nm.

(5) The inorganic particles comprise colloidal silica.

(6) The colloidal silica is globular colloidal silica.

(7) The colloidal silica is chain colloidal silica comprising silica micro-particles connected together in series.

(8) The colloidal silica is a mixture of globular colloidal silica and chain colloidal silica comprising silica micro-particles connected together in series.

(9) The metal oxide is silicon oxide.

(10) The metal oxide is prepared from a metal alkoxide compound by a sol-gel method.

(11) The mixed metal oxide particle-polyimide layer is prepared by coating a metal alkoxide compound on a polyamic acid film containing an organic solvent, causing a sol-gel reaction, and heating a layer produced by the sol-gel reaction.

(12) The polyimide film contains dispersed inorganic particles having a mean particle size of 1,000 nm or less (preferably 3 to 500 nm).

(13) The polyimide film comprises tetracarboxylic acid units selected from the group consisting of 3,3′,4,4′-biphenyltetracarboxylic acid units or a mixture of 3,3′,4,4′-biphenyltetracarboxylic acid units and pyromellitic acid units and diamine units of 4,4′-diaminobenzene or a mixture of 4,4′-diaminobenzene and 4,4′-diaminodiphenyl ether.

(14) The polyimide film has a thickness in the range of 5 to 150 μm.

(15) The coated particle layer is bonded to the polyimide film at a 90° peel strength of 0.5 N/mm or more.

(16) The metal film layer comprises a metal film formed by vapor deposition and a plated metal film placed in order on the coated particle layer.

(17) The metal film is a copper metal film.

(18) The metal film layer is bonded to the polyimide film at a 90° peel strength of 0.5 N/mm or more.

The polyimide film of the invention having enhanced surface activity can be prepared by a process comprising the steps of:
coating at least one surface of a polyamic acid film containing a polar organic solvent with a solution comprising a metal alkoxide-containing aqueous organic solvent solution and inorganic particles having a mean particle size of 1,000 nm or less dispersed therein;
drying the coated solution to form a coated layer; and
heating the polyimide film with the coated layer to a temperature of 300° C. or higher.

In the above-mentioned process, the polyamic acid (or polyamide acid) containing a polar organic solvent can be prepared by a known polymerization reaction between an aromatic tetracarboxylic acid compound and an aromatic diamine compound in a polar organic solvent.

Examples of the aromatic tetracarboxylic acid compounds include 3,3′,4,4′-biphenyltetracarboxylic acid, 2,3,3′,4′-biphenyltetracarboxylic acid, 3,3′,4,4′-benzophenonetetracarboxylic acid, 3,3′,4,4′-diphenylether tetracarboxylic acid, bis(3,4-dicarboxyphenyl)methane, 2,2-bis(3,4-dicarboxyphenyl)propane, pyromellitic acid, 1,4,5,8-naphthalanetetracarboxylic acid, 3,4,9,10-perylenetetracarboxylic acid, and acid dianhydrides thereof, and esters thereof. Preferred aromatic tetracarbo)ylic acid compounds are 3,3′,4,4′-biphenyltetracarboxylic dianhydride and a combination of 3,3′,4,4′-biphenyltetracarkoxylic dianhydride and pyromellitic dianhydride. These preferred compounds can be employed in combination with a relatively small amount of aromatic or aliphatic tetracarboxylic acid compounds.

Examples of the aromatic diamine compounds include 4,4′-diaminobenzene (p-phenylene diamine), 4,4′-diaminophenyl ether, 3,3′-diaminophenyl ether, 2,2-bis[4-(4-aminophenoxy)phenyl]propane, 1,3-bis(3-aminophenoxybenzene), 1,3-bis(4-aminophenoxybenzene), and dimethylphenylene diamine. Preferred aromatic diamine compounds are 4,4′-diaminobenzene and a combination of 4,4′-diaminobenzene and 4,4′-diaminodiphenyl ether. These preferred compounds can be employed in combination with a relatively small amount of aromatic or aliphatic diamine compounds.

Examples of the polar organic solvents to be used as a solvent for the polymerization reaction between the aromatic tetracarboxylic acid compound and aromatic diamine compound include amides such as N-methyl-2-pyrrolidone, N, N-dimethylacetamide, N, N-diethylacetamide, N, N-dimethylformamide, N,N-diethylformamide; sulfoxides such as dimethyl sulfoxide and diethyl sulfoxide; and sulfones such as dimethyl sulfone and diethyl sulfone. These solvents can be employed singly or in combination.

The polymerization reaction for preparing a polyamic acid solution can be performed using a solution of 5 to 40 wt. %, preferably 6 to 35 wt. %, more preferably 10 to 30 wt. %, of monomers (reactants such as the aromatic tetracarboxylic acid compound and aromatic diamine compound) in a polar organic solvent. For instance, the aromatic tetracarboxylic acid compound and aromatic diamine compound are mixed in essentially equimolar amounts in the polar organic solvent, and the resulting solution is heated to a temperature not higher than 100° C., preferably not higher than 80° C., for approx. 0.2 to 60 hours.

The polyamic acid solution to be used for preparing a polyimide film of the invention generally shows a rotary viscosity (measured at 30° C.) of approx. 0.1 to 50,000 poises, preferably 0.5 to 30,000 poises, more preferably 1 to 20,000 poises, so that the polyamic acid solution can be easily handled. Therefore, it is desired that the polymerization reaction be carried out to give a polyamic acid solution having the above-mentioned viscosity.

The polyimide film of the invention can be prepared in the following manner.

The polyamic acid solution is spread on a surface of an appropriate sport (for example, roll of metal, ceramic, or plastic material; metallic belt, or roll or belt on which a thin metal tape is supplied) to form a polyamic acid solution film having a uniform thickness in the range of approx. 10 to 2,000 μm, specifically 20 to 1,000 μm. The solution film is then heated to a temperature of 50 to 210° C., specifically 60 to 200° C. by a heat source such as hot air or infra-red heating means to slowly remove the solvent until a self-supporting polyimide film is formed. The self-supporting polyimide film is separated from the support. The self-supporting polyimide film preferably is in the form of a continuous film.

The self-supporting polyimide film preferably contains the polar organic solvent in an amount of 20 to 48 wt. %., specifically 24 to 41 wt. %. The self-supporting film preferably has an imidation ratio in the range of 8 to 40%, specifically 8 to 28%.

The self-supporting film may have fine inorganic or organic particles dispersed in or on the film. Preferred examples of the inorganic particles are inorganic particles having a mean particle size of 1,000 nm or less which are distributed on the polyimide film. The details of the preferred inorganic particles are described hereinbelow.

Subsequently, a aqueous organic solution containing a metal alkoxide and dispersed inorganic particles having a mean particle size of 1,000 nm or less (preferably 500 nm or less, more preferably 200 nm or less, most preferably 100 nm or less; preferably 3 nm or more, more preferably 10 nm or more), that is, a coating solution (i.e., metal alkoxide sol solution containing dispersed inorganic particles) is coated on the above-mentioned self-supporting film on one side or both sides. The coating solution is preferably coated in amount of 1 to 30 g/m², more preferably 3 to 23 g/m².

The inorganic particles are preferably contained in the sol solution in an amount of 0.1 to 8 wt. %, more preferably 0.1 to 5 wt. %.

Examples of the inorganic particles include silica (particularly colloidal silica), titanium dioxide, calcium carbonate, iron oxide, magnesium oxide and alumina. The inorganic particle can take any forms such as globular, rod, shirt fiber, oval, needle, and plate.

Most preferred inorganic particles are colloidal silica, particularly colloidal silica comprising globular silica fine particles or a chain colloidal silica containing silica fine particles connected in series. The globular silica fine particles and the chain colloidal silica containing silica fine particles connected in series can be combined. In the specification, the mean particle size of the chain colloidal silica is a mean particle size of the silica fine particles constituting the chain structure.

The metal alkoxide compound for the use of production of the above-mentioned sol solution preferably is a hydrolytic metal alkoxide having the following formula:

R¹ₙM(OR²)ₘ₋ₙ

[in the formula, R¹ represents a non-hydrolytic group; R² represents an organic group such as an alkyl group having 1 to 5 carbon atoms; M represents a metal atom; m is an atomic valency of the metal atom; and n is an integer satisfying the condition of 0≦n<m-1; provided that each R¹ can be the same or different, if R¹ is plurally present, and each R² can be the same or different, if R² is plurally present].

Examples of the non-hydrolytic groups for R¹ include hydrogen; a alkyl group such as methyl, ethyl, propyl, butyl and pentyl; phenyl, a phenyl group having a substituent, for example, 4-methylphenyl; and an alkylene or alkylidene group having one or more functional groups such as isocyanate, epoxy, carboxyl, acid halide, acid anhydride, amino, thiol, vinyl, methacryl and halogen.

Examples of the organic groups for R² include aikyl groups having 1 to 5 carbon atoms such as methyl, ethyl, propyl, butyl and pentyl.

Examples of metal atoms for M include Si, Al, Ti, Zr, In, Sn, Sb, Ba, Nb and Y. Si is particularly preferred.

Examples of the metal alkoxide compounds in which the metal atom is Si include alkoxysilanes such as tetramethoxysilane, tetraethoxysilane, tetra-n-propoxysilane, tetraisopropoxysilane, tetra-n-butoxysilane, tetraisobutoxysilane, tetra-sec-butoxysilane and tetra-tertbutoxysilane; methyltrimethoxysilane; methyltriethoxysilane, ethyltrimethoxysilane, ethyltriethoxysilane, n-propyltrimethoxysilane, n-propyltriethoxysilane, phenyltrimethoxysilane, phenyltriethoxysilane; and alkoxysilanes having an isocyanate group, such as 3-isocyanate propyltriethoxysilane, 2-isocyanate ethyltriethoxysilane, 3-isocyanate propylmethyldiethoxysilane, 2-isocyanate ethylethyldiethoxysilane and di(3-isocyanatepropyl)diethoxysilane.

Further examples of the metal alkoxide compounds in which the metal atom is Si include alkoxysilanes having an epoxy group, such as 3-glycidoxypropyltrimethoxysilane, 3-glycidoxypropyltriethoxysilane, 3-glycidoxypropylmethyldiethoxysilane, 2-(3,4-epoxycyclohexyl)ethyltriethoxysilane and 3,4-epoxyutyltrimethoxysilane; alkoxysilanes having a carboxyl group, such as carboxymethyltriethoxysilane, carboxyethyltriethoxysilane and carboxymethyltri-n-propoxysilane; alkoxysilanes having an acid anhydride group, such as, 3-(triethoxysilyl)-2-methylpropylsuccinic anhydride and 3-(trimethoxysilyl)-2-methylpropylsuccinic anhydride; alkoxysilanes having an acid halide group, such as 2-(4-chlorosulfonylphenyl)-ethyltriethoxysilane and 2-(4-chlorosulfonylphenyl)ethyltrimethoxysilane; alkoxysilanes having an amino group, such as 3-aminipropyltrimethoxysilane, 3-aminopropyltriethoxysilane, 3-[2-(2-aminoethylaminoethylaino) propyl]-trimethoxysilane, 2-aminoethylaminomethyltrimethoxy-silane, 3-(2-aminoethylaminoprcpyl)dimethoxymethylsilane, 3-(2-aminoethylaminapropyl)trimethoxysilane, 3-(2-aminoethylaminopropyl)triethoxysilane, 2-(2-aminoethylthioethyl)diethoxymethylsilane, 2-(2-aminoethylthioethyl)triethoxysilane, N-2-(aminoethyl)-3-aminopropyltriethoxysilane, N-2-(aminoethyl)-3-aminopropylmethyldiethoxysilane, and 3-phenylaminopropyltrimethoxysilane; alkoxysilanes having a thiol group, such as 3-mercaptopropyltriethoxysilane, 3-mercaptopropyltrimethoxysilane, 2-mercaptoethyltriethoxysilane and 3-mercaptopropylmethyldiethoxysilane; alkoxysilanes having a vinyl group, such as vinyltrimethoxysilane, vinyltriethoxysilane and vinylmethyldiethoxysilane; alkoxysilanes having a rethacryl group, such as 3-methacryloxypropyltrimethoxysilane, 3-methacryloxypropylmethyldiethoxysilane; and alkoxysilanes having a halogen atom, such as 3-chlorcpropyltriethoxysilane, 3-chloropropyltrimethoxysilane, 3-bromopropyltriethoxysilane and 2-chloroethyltriethoxysilane.

As for the metal alkoxide compounds in which the metal atom is other than Si, such as Al, Ti, Zr, In, Sn, Sb, Ba, Nb, or Y, the above-mentioned compounds in which Si is replaced with other metal atom can be employed.

The metal alkoxides can be employed singly or in combination.

In addition, the metal alkoxide compound can be a metal alkoxide compound having two or more metal atom in one molecule, such as Mg[Al(iso-OC₃H₇)₄]₂, Ba[Zr(OC₂H₅)₉]₂, and (iso-C₃H₇O)₂Zr[Al(iso-OC₃H₇)₄]₂; or a metal alkoxide compound of an oligomer type having two or more repeated units in one molecule, such as of tetramethoxysilane-oligomer type or of tetraethoxysilane oligomer type. Otherwise, the alkoxy group can be an acetoxy group or an acetylacetoxy group.

The sol solution containing inorganic particles (i.e, inorganic particle-containing sol) can be prepared by bringing a metal alkoxide compound dissolved in an organic solvent into contact with water, whereby subjecting the metal alkoxide compound to hydrolysis and condensation. The reaction of the metal alkoxide compound for hydrolysis and condensation is preferred by the use of an organic solvent and water. The hydrolysis can be performed in the presence of an acid catalyst such as hydrochloric acid, nitric acid, and oxalic acid. The acid catalyst is preferably employed in an amount of 0.01 to 5 mol. %, more preferably 0.05 to 3 mol. %, per one mole of the metal alkoxide compound, for producing the sol.

The water is employed preferably in an amount of 0.8 to 20 moles, more preferably 1 to 15 moles, per one mole of the metal alkoxide compound, for the production of the sol. Examples of the organic solvents for the use for the sol production are organic solvents compatible with water such as acetone, methanol, ethanol, n-propanol, isoprcpanol, n-butanol, isobutanol, sec-butanol, tertbutanol, N-methyl-2-pyrrolidone, N,N-dimethylacetamide, N,N-dimethylformamide, 1,3-dimethyl-2-imidazolidinone diglyme, triglyme, ethylene glycol, propylene glycol, bexylene glycol, ethylene glycol monomethyl ether, and γ-butylolactone. The organic solvents can be employed singly or in combination. The amount of the organic solvent may vary dependent upon the natures of the metal alkoxide con-pound and the organic solvent, and preferably is 0.5 to 15 moles, more preferably 0.5 to 10 moles, most preferably 0.8 to 10 moles, per one mole of the metal alkoxide compound.

The reaction for the production of sol can be performed generally at a temperature of 10 to 80° C., preferably 20 to 60° C.

Before the inorganic particle-containing sol solution is coated on the self-supporting polyamic acid film, the above-obtained sol solution is preferably diluted with an appropriate organic solvent. Examples of the diluents for diluting the sol solution include alcoholic solvents (e.g., methanol and ethanol), amide solvents (e.g., N,N-dimethylacetamide), ketone solvents (e.g. acetone), and ether solvents (e.g., tetraydrofuran). Most preferred is acetone.

It is desirable to incorporate an organic polymer having a low thermal decomposition temperature into the inorganic particle-containing sol solution. There are no specific limitations with respect to the polymer, so far as it has a thermal decomposition temperature in the range of 300 to 450° C. which corresponds to a temperature for producing the polyimide by heating. Examples of the polymers include polyether, polyester, polycarbonate, polyanhydride, polyamide, polyurethane, polyurea, polyacrylic acid, polyacrylate ester, polymethacrylic acid, polymethacrylate ester, polyacrylamide, polymethacrylamide, polyacrylonitrile, polymethacrylonitrile, polyolefin, polydiene, poly(vinyl ether), poly(vinyl ketone), polyvinylamide, polyvinylamine, poly(vinyl ester), poly(vinyl alcohol), poly(halogenated vinyl), poly(halogenated vinylidene), polystyrene, polysiloxane, polysulfide, polysulfone, polyimine, cellulose, saccharide, cyclodextrin, and their derivatives.

The inorganic particle-containing sol solution can be coated on the self-supporting polyamic acid film by a known coating methods, such as gravure coating, spin coating, silk screen coating, dip coating, spray coating, bar coating, knife coating, roll coating, blade coating, and die coating.

The self-supporting polyamic acid film on which the inorganic particle-containing sol solution is coated is preferably dried at 0 to 50° C., preferably 15 to 40° C., for 0.1 to 3 hours, preferably 0.3 to 1 hours, for evaporating the sol solvent, whereby forming a sol layer containing the inorganic particles.

The self-supporting polyamic acid film on which the inorganic particle-containing sol layer is formed is fixed by fixing means such as pin tentors, clips, or fixing metal aids, and then cured by heating. The heating can be preferably performed by three steps, that is, a first step for heating at 200 to 300° C. for 1 to 60 minutes, a second step for heating at 300 to 370° C. for 1 to 60 minutes, and a third step for heating to a maximum temperature of 370 to 450° C. for 1 to 30 minutes. Thus, the heating procedure is preferably performed by multiple steps. The heating can be performed by means of a known apparatus such as a hot air oven or an infrared heating furnace.

By the heating, the sol turns to gel forming a metal oxide layer, while the polyamic acid is imidized by ring closure, whereby producing the desired polyimide film having enhanced surface activity. Thus produced polyimide film having enhanced surface activity preferably has a layer of the following thickness:
(1) the thickness of the coated particle layer comprising inorganic particles (mean particle size: 1,000 nm or less) having a metal oxide coat: approx. 1,000 nm or less, preferably 500 nm or less, more preferably 3 to 100 nm;
(2) the thickness of a layer comprising a mixture of the same metal oxide and polyimide: approx. 10 to 1,000 nm.

The polyimide film of the invention having enhanced surface activity can be converted into a polyimide film having a metal film layer which can be favorably employed for CCL or the like, by the following procedures:
a metal film layer (underlying layer, generally having a thickness of 1 μm or less) is formed on the coated particle layer of the polyimide film by a gas accumulation method such as sputtering or vapor deposition, and then a thick metal layer (generally having a thickness of 1 to 40 μm, metal: an electro-conductive metal such as copper) is formed on the underlying layer by plating. The underlying layer can be made of titanium, chromium, or nickel-chromium alloy. The electro-conductive metal other than copper for the thick metal layer can be copper alloy, aluminum, tin, tin alloy, or palladium.

The polyimide film having enhanced surface activity on which the metal film layer is formed preferably is a continuous polyimide film. The underlying layer and thick metal layer are preferably formed on the polyimide film using continuous rolls.

The examples the invention and comparison examples are given below.

### EXAMPLE 1

(1) Preparation of Self-Supporting Polyamic Acid Film

In a 300 mL-volume glass reaction vessel equipped with a stirrer, a nitrogen inlet and a reflux condenser were placed 183 g of N,N-dimethylacetamide and 0.1 g of a phosphoric acid compound (SEPARL 365-100, available from Chuko Oil And Fat Co., Ltd.). The content in the reaction vessel was stirred in an nitrogen gas stream, and 10.8 g (0.1000 mol) of p-phenylenediamine was added. The resulting mixture was kept at 50° C. until the mixture completely turned into a solution. To the solution was slowly added 29.229 g (0.09935 mol) of 3,3′,4,4′-biphenyltetracarboxylic dianhydride, keeping exothermic reaction low. After the addition was complete, the reaction was continued at 50° C. for 6 hours, to give a polyamic acid solution. Subsequently, 0.1 wt. % (in term of solid content amount) of colloidal silica (globular colloidal silica, DMAC-ST-YL, mean particle size 60-70 nm, available from Nissan Chemical Industries, Co., Ltd.) was added to the polyamic acid solution. Then, 0.2381 g (0.00065 mol) of 3,3′,4,4′-biphenyltetracarboxylic dianhydride was added, and dissolved. The resulting polyamic acid solution containing colloidal silica was a viscous brown liquid (solution viscosity at 25° C.: approx. 1,500 poises).

The polyamic acid solution containing colloidal silica was spread on a glass plate, dried at 120° C. for 60 minutes, to produce a self-supporting polyamic acid film having a solution content of 29.7 wt. % and an imidation ratio of 27.5%.

(2) Preparation of Sol Solution Containing Colloidal Silica

In a 50 mL-volume glass vessel were placed 12.40 g (0.056 mol), 3.03 g (0.168 mol) of water, 48.79 g (0.56 mol) of N,N-dimethylacetamide, and 11.21 g (0.112 mol) of acetylacetone. The mixture was stirred at room temperature for 2 hours, to give a sol solution. The sol solution was diluted with N,N-dimethylacetamide to give a sol solution which should contain 1 wt. % of a solid product corresponding to silicon oxide (SiO_{1.5}) formed by sol-gel reaction. Subsequently, 1 wt. % (in term of a solid content) of colloidal silica (globular colloidal silica, EMC-ST, mean particle size 10-15 nm, available from Nissan Chemical Industries, Co., Ltd.) was added to the sol solution, to give a colloidal silica-containing coating solution.

(3) Preparation of Polyimide Film According to Invention

The colloidal silica-containing sol coating solution prepared in (2) above was coated on one surface of the self-supporting polyamic acid film prepared in (1) above at a coating amount of 7 g/m². The coated solution was dried in air at room temperature for 15 minutes. The polyamic acid film with a dry coated layer was separated from the glass plate and fixed within a frame. The fixed polyamic acid film was first heated to 250° C. at 10° C./min., second kept under heating at 250° C. for 15 min., third heated to 350° C. at 10° C./min., fourth kept under heating at 350° C. for 30 min., fifth heated to 400° C. at 10° C./min., and finally kept under heating at 400° C. for 15 min., to give a polyimide film (thickness: approx. 50 μm) of the invention.

The atomic concentrations of carbon, nitrogen, oxygen and silicon on the film surface were analyzed by ESCA (scanning X-ray photoelectron spectrochemical analysis) to give the following results:

carbon 40.8%, nitrogen 3.86%, oxygen 40.0%, and silicon 15.6%.

Further, a SEM photo and a TEM photo of the surface of the polyimide film were taken, which indicated that the polyimide film had on its surface a coated particle layer comprising colloidal silica particles coated with silicon oxide via a layer of a mixture of silicon oxide and polyimide.

(4) Manufacture of Polyimide Film Having Metal Film Layer According to Invention

A copper film was formed on the polyimide film prepared in (3) above by sputtering. The sputtering was carried out by means of SPK-503 (available from Tokki Corporation) in the following manner. The polyimide film was cut to give a specimen of a holder size. The specimen was set in the sputtering apparatus. The surface of the specimen was first cleaned by high frequency sputtering at a temperature of 27 to 31° C. and a pressure of not higher than 2×10⁻⁴ Pa, and then subjected to sputtering at a temperature of 27 to 31° C., a pressure of not higher than 2×10⁻⁴ Pa and a sputtering rate of approx. 15 angstroms/sec, to produce a copper film having a thickness of 4,000 angstroms.

Subsequently, a copper layer having a thickness of approx. 20 μm was formed on the above-produced copper film by electroplating, to give a polyimide film having a metal film layer according to the invention. The polyimide film having a metal film layer showed the following peel strength (90° peel strength according to JIS-C-6471):
1) initial peel strength: 0.82 N/mm
2) peel strength after heating at 150° C. for 168 hrs.: 0.81 N/mm
3) peel strength (PCT) after subjecting to test for evaluating resistance to moist heat (121° C., RH 100%, vapor pressure 2 atm., 24 hrs.): 0.34 N/mm.

### EXAMPLE 2

(1) Self-Supporting Polyamic Acid Film

The self-supporting polyamic acid film prepared in Example 1-(1) was employed.

(2) Preparation of Sol Solution Containing Colloidal Silica

The procedures of Example 1-(2) were repeated except that the amount of colloidal silica (globular colloidal silica DMAC-ST) was changed to 1.5 wt. % (in terms of amount of solid content), to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyirnide film (thickness: approx. 50 μm) according to the invention.

The atomic concentrations of carbon, nitrogen, oxygen and silicon on the film surface were analyzed by ESCA to give the following results:
carbon 31.2%, nitrogen 2.67%, oxygen 47.0%, and silicon 15.1%.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.78 N/mm
2) peel strength after heating at 150° C. for 168 hrs.: 0.64 N/mm
3) peel strength (PCr): 0.30 N/mm.

### EXAMPLE 3

(1) Self-Supporting Polyamic Acid Film

The self-supporting polyamic acid film prepared in Example 1-(1) was employed.

(2) Preparation of Sol Solution Containing Colloidal Silica

The procedures of Example 1-(2) were repeated except that the polyamic acid solution prepared in Example 1-(1) was added to the prepared sol solution in an amount of 1 wt. % (in terms of amount of solid content) prior to the addition of the colloidal silica (globular colloidal silica DMAC-ST), to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

The atomic concentrations of carbon, nitrogen, oxygen and silicon on the film surface were analyzed by ESCA to give the following results:
carbon 32.1%, nitrogen 2.94%, oxygen 46.1%, and silicon 18.9%.

(4) Manufacture of Polyimide Film Having Metal Film Layer According to Invention

The procedures of Example 1-(4) were repeated using the polyimide film prepared in (3) above, to give a polyimide film having a metal film layer according to the. invention.

The polyimide film having a metal film layer showed the following 90° peel strength:
1) initial peel strength. 0.75 N/mm
2) peel strength after heating at 150° C. for 168 hrs.: 0.66 N/mm
3) peel strength (PCT); 0.38 N/mm.

### EXAMPLE 4

(1) Self-Supporting Polyamic Acid Film

The self-supporting polyamic acid film prepared in Example 1-(1) was employed.

(2) Preparation of Sol Solution Containing Colloidal Silica

The colloidal silica-containing sol solution prepared in Example 1-(2) was employed.

(3) Preparation of Polyimide Film of Invention

The colloidal silica-containing sol coating solution prepared in (2) above was coated on one surface (A surface) of the self-supporting polyamic acid film prepared in (1) above. The coated solution was dried in air at room temperature for 15 minutes. The polyamic acid film with a dry coated layer was separated from the glass plate and fixed within a frame. The same colloidal silica-containing sol coating solution was then coated on another surface (B surface) of the fixed polyamic acid film. The coated solution was dried in air at room temperature for 15 minutes. Subsequently, the fixed polyamic acid film was first heated to 250° C. at 10° C./min., second kept under heating at, 250° C. for 15 min., third heated to 350° C. at 10° C./min., fourth kept under heating at 350° C. for 30 min., fifth heated to 400° C. at 10° C./min., and finally kept under heating at 400° C. for 15 min., to give a polyimide film (thickness: approx. 50 μm) having an activated surface on both sides according to the invention.

(4) Manufacture of Polyimide Film Having Metal Film Layer According to Invention

The procedures of Example 1-(4) were repeated on both sides of the polyimide film using the polyimide film prepared in (3) above, to give a polyimide film having metal film layers according to the invention.

The polyimide film having metal film layers showed the following 90° peel strength (on the B surface):
1) initial peel strength: 0.75 N/mm
2) peel strength after heating at 150° C. for 168 hrs.: 0.63 N/mm
3) peel strength (PCT): 0.15 N/mm.

### COMPARISON EXAMPLE 1

(1) Self-Supporting Polyamic Acid Film

The self-supporting polyamic acid film prepared in Example 1-(1) was employed.

(2) Preparation of Coating Solution Containing Colloidal Silica

A colloidal silica (globular colloidal silica DMAC-ST) was added to N,N-dimethylacetamide in an amount of 1 wt. % (in terms of amount of solid content) to prepare a colloidal silica-containing coating solution (which was not a sol solution).

(3) Preparation of Polyimide Film for Comparison

The procedures of Example 1-(3) were repeated using the self-supporting polyamic film of (1) above and the colloidal silica-containing coating solution prepared in (2) above, to prepare a polyimide film (thickness: approx. 50 μm) for comparison.

The atomic concentrations of carbon, nitrogen, oxygen and silicon on the film surface were analyzed by ESCA to give the following results:
carbon 23,6%, nitrogen 1.62%, oxygen 54.2%, and silicon 20.5%.

(4) Manufacture of Polyimide Film Having Metal Film Layer for Comparison

The procedures of Example 1-(4) were repeated using the polyimide film prepared in (3) above, to give a polyimide film having a metal film layer for comparison.

The polyimide film having a metal film layer showed the following 90° peel strength:
1) initial peel strength: 0.22 N/mm
2) peel strength after heating at 150° C. for 168 hrs.: 0.13 N/mm
3) peel strength (PCT): 0.18 N/mm.

### COMPARISON EXAMPLE 2

(1) Self-Supporting Polyamic Acid Film

The self-supporting polyamic acid film prepared in Example 1-(1) was employed.

(2) Preparation of Sol Solution

The procedures of Example 1-(2) were repeated except that the colloidal silica (globular colloidal silica DMAC-ST) was not added, to prepare a sol solution containing no colloidal silica.

(3) Preparation of Polyimide Film for Comparison

The procedures of Example 1-(3) were repeated using the self-supporting polyamic film of (1) above and the sol solution prepared in (2) above, to prepare a polyimide film (thickness: approx. 50 μm) for comparison.

(4) Manufacture of Polyimide Film Having Metal Film Layer for Comparison

The procedures of Example 1-(4) were repeated using the polyimide film prepared in (3) above, to give a polyimide film having a metal film layer for comparison.

The polyimide film having a metal film layer showed the following 90° peel strength:
1) initial peel strength: 0.61 N/mm
2) peel strength after heating at 150° C. for 168 hrs.: 0.28 N/mm

3) peel strength (PCT): 0.25 N/mm.

### COMPARISON EXAMPLE 3

(1) Self-Supporting Polyamic Acid Film

The self-supporting polyamic acid film was fixed within the frame. The fixed polyamic acid film was first heated to 250° C. at 10° C./min., second kept under heating at 250° C. for 15 min., third heated to 350° C. at 10° C./min., fourth kept under heating at 350° C. for 30 min., fifth heated to 400° C. at 10° C./min., and finally kept under heating at 400° C. for 15 min., to give a polyimide film (thickness: approx. 50 μm).

(2) Preparation of Solution Containing Colloidal Silica

The colloidal silica-containing sol solution prepared in Example 1-(2) was employed.

(3) Preparation of Polyimide Film for Preparation

The sol solution prepared in (2) above was coated and dried on the self-supporting polyamic film of (1) above, to prepare a polyimide film (thickness: approx. 50 μm) for comparison.

(4) Manufacture of Polyimide Film Having Metal Film Layer for Comparison

The procedures of Example 1-(4) were repeated using the polyimide film prepared in (3) above, to give a polyimide film having a metal film layer for comparison.

The metal film layer easily separated from the polyimide film. Therefore, 90° peel strength could not be measured.

### EXAMPLE 5

(1) Self-Supporting Polyamic Acid Film

The procedures of Example 1-(1) were repeated except that the drying conditions for the colloidal silica-containing polyamic acid solution spread on the glass plate was changed to 120° C. for 30 minutes, to prepare a self-supporting polyamic acid film having a solution content of 36.5 wt. % and an imidation ratio of 15.0%.

(2) Preparation of Sol Solution Containing Colloidal Silica

The procedures of Example 1-(2) were repeated except that the colloidal silica (globular colloidal silica DMAC-ST) was replaced with a chain colloidal silica (DMAC-ST-UP, mean particle size: 5 to 20 μm, length of chain: 40 to 300 nm, available from Nissan Chemical Industries, Co., Ltd.) in the same amount, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.78 N/mm
2) peel strength after heating at 150° C. for 168 hrs.: 0.72 N/mm
3) peel strength (PCT): 0.58 N/mm.

### EXAMPLE 6

(1) Self-Supporting Polyamic Acid Film

The self-supporting polyamic acid film prepared in Example 5-(1) was employed.

(2) Preparation of Sol Solution Containing Colloidal Silica

The procedures of ample 1-(2) were repeated except that the amount of the chain colloidal silica (DMAC-ST-UP, mean particle size: 5 to 20 nm, length of chain: 40 to 300 nm) was changed to 0.5 wt. %, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.72 N/mm
2) peel strength after heating at 150° C. for 168 hrs.: 0.61 N/mm
3) peel strength (PCT): 0.48 N/mm.

### EXAMPLE 7

(1) Self-Supporting Polyamic Acid Film

The self-supporting polyamic acid film prepared in Example 5-(1) was employed.

(2) Preparation of Sol Solution Containing Colloidal Silica

The procedures of Example 1-(2) were repeated except that the sol solution was prepared to contain 2 wt. % of a solid product corresponding to silicon oxide (SiO_{1.5}) formed by sol-gel reaction, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer shoed the following 90° peel strength:
1) initial peel strength: 0.88 N/mm
2) peel strength after heating at 150° C. for 168 hrs.: 0.75 N/mm
3) peel strength (PCT). 0.20 N/mm.

### EXAMPLE 8

(1) Self-Supporting Polyamic Acid Film

The self-supporting polyamic acid film prepared in Example 5-(1) was employed.

(2) Preparation of Sol Solution Containing Colloidal Silica

The procedures of Example 1-(2) were repeated except that the amount of colloidal silica (globular colloidal silica DMC-ST) was changed to 2 wt. %(in terms of amount of solid content), to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.65 N/mm
2) peel strength after heating at 150° C. for 168 hrs.: 0.59 N/mm
3) peel strength (PCT): 0.38 N/mm.

### EXAMPLE 9

(1) Self-Supporting Polyamic Acid Film

The self-supporting polyamic acid film prepared in Example 5-(1) was employed.

(2) Preparation of Sol Solution Containing Colloidal Silica

The procedures of Example 1-(2) were repeated except that the amount of N,N-dimethylacetamide was reduced to 24.4 g (0.28 mol, half), the amount of colloidal silica (globular colloidal silica DMC-ST) was changed to 1.5 wt. %, and the sol solution was prepared to contain 4 wt. % of a solid product corresponding to silicon oxide (SiO_{1.5}) formed by sol-gel reaction, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.80 N/mm
2) peel strength after heating at 150° C. for 168 hrs.: 0.66 N/mm
3) peel strength (PCT): 0.19 N/mm.

### EXAMPLE 10

(1) Self-Supporting Polyamic Acid Film

The self-supporting polyamic acid film prepared in Example 5-(1) was employed.

(2) Preparation of Sol Solution Containing Colloidal Silica

The procedures of Example 1-(2) were repeated except that the amount of N,N-dimethylacetamide was reduced to 24.4 g (0.28 mol, half), the colloidal silica was replaced with another globular colloidal silica (DMAC-ST-YL, mean particle size: 60-70 nm, available from Nissan Chemical Industries, Co., Ltd.), and the sol solution was prepared to contain 4 wt. % of the solid product, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.93 N/mm
2) peel strength after heating at 150° C. for 168 hrs.: 0.77 N/mm
3) peel strength (PCT): 0.25 N/mm.

### EXAMPLE 11

(1) Self-Supporting Polyamic Acid Film

The self-supporting polyamic acid film prepared in Example 5-(1) was employed.

(2) Preparation of Sol Solution Containing Colloidal Silica

The procedures of Example 1-(2) were repeated except that the amount of N,N-dimethylacetamide was reduced to 24.4 g (0.28 mol, half), the colloidal silica was replaced with another globular colloidal silica (IC-ST-ZL, mean particle size: 70-100 nm, available from Nissan Chemical Industries, Co., Ltd.), and the sol solution was prepared to contain 5 wt. % of the solid product, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.73 N/mm
2) peel strength after heating at 150° C. for 168 hrs.: 0.51 N/mm
3) peel strength (PCT); 0.17 N/mm.

### EXAMPLE 12

(1) Self-Supporting Polyamic Acid Film

The self-supporting polyamic acid film prepared in Example 5-(1) was employed.

(2) Preparation of Sol Solution Containing Colloidal Silica

The procedures of Example 1-(2) were repeated except that the amount of N,N-dimethylacetamide was reduced to 24.4 g (0.28 mol, half), the colloidal silica was replaced with another globular colloidal silica (DMAC-ST-YL, mean particle size: 60-70 nm, available from Nissan Chemical Industries, Co., Ltd.), and the sol solution was prepared to contain 4 wt. % of a solid product corresponding to silicon oxide (SiO_{1.5}) formed by sol-gel reaction, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.8 N/mm
2) peel strength after heating at 150° C. for 168 hrs.: 0.67 N/mm
3) peel strength (PCT): 0.22 N/mm.

### EXAMPLE 13

(1) Preparation of Self-Supporting Polyamic Acid Film

In a 500 ml-volume glass reaction vessel equipped with a stirrer, a nitrogen inlet and a reflux condenser were placed 357.1 g of N,N-dimethylacetamide and 0.16 g of a phosphoric acid compound (SEPARL 365-100). The content in the reaction vessel was stirred in an nitrogen gas stream, and 15.14 g (0.14 mol) of p-phenylenediamine and 12.01 g (0.06 mol) of 4,4′-diaminodiphenyl ether were added. The resulting mixture was kept at 50° C. until the mixture completely turned into a solution. To the solution were slowly added 29.40 g (0.10 mol) of 3,3′,4,4′-biphenyltetracarboxylic dianhydride and 21.81 g (0.10 mol) of pyromellitic dianhydride, keeping exothermic reaction low. After the addition was complete, the reaction was continued at 50° C. for 6 hours, to give a viscous brown polyamlc acid solution (solution viscosity at 25° C.: approx. 1,600 poises).

Thus obtained polyamic acid solution was spread on a glass plate, dried at 120° C. for 30 minutes, to produce a self-supporting polyamic acid film having a solution content of 40.0 wt. % and an imidation ratio of 15.9%.

(2) Preparation of Sol Solution Containing Colloidal Silica

The procedures of Example 1-(2) were repeated except that the amount of N,N-dimethylacetamide was reduced to 24.4 g (0.28 mol, half), the amount of the globular colloidal silica (DMAC-ST) was changed into 1.5 wt. % in terms of the solid content, and the sol solution was prepared to contain 1.5 wt. % of a solid product corresponding to silicon oxide (SiO_{1.5}) formed by sol-gel reaction, to prepare a sol solution containing colloidal silica.

(3) Preparation of Polyimide Film of Invention

The procedures of Example 1-(3) were repeated using the self-supporting polyamic film of (1) above and the colloidal silica-containing sol solution prepared in (2) above, to prepare a polyimide film (thickness: approx. 50 μm) according-to the invention.

(4) Manufacture of Polyimide Film Having Metal Film Layer According to Invention

The procedures of Example 1-(4) were repeated using the polyimide film prepared in (3) above, to give a polyimide film having a metal film layer according to the invention.

The polyimide film having a metal film layer showed the following 90° peel strength:
1) initial peel strength: 0.66 N/nm
2) peel strength after heating at 150° C. for 168 hrs.: 0.55 N/mm
3) peel strength (PCT): 0.26 N/mm.

What is claimed is:

1. A polyimide film having, at least on one surface thereof, a coated particle layer comprising inorganic particles having a mean particle size of 1,000 nm or less which are coated with a metal oxide coverage via an intervening layer comprising a mixture of the same metal oxide as above and polyimide.

2. The polyimide film of claim 1, wherein the mean particle size of the inorganic particles are less than 500 nm.

3. The polyimide film of claim 1, wherein the mean particle size of the inorganic particles are in the range of 3 to 100 nm.

4. The polyimide film of claim 1, wherein the inorganic particles comprise colloidal silica.

5. The polyimide film of claim 4, wherein the colloidal silica is globular colloidal silica.

6. The polyimide film of claim 4, wherein the colloidal silica is chain colloidal silica comprising silica micro-particles connected in series.

7. The polyimide film of claim 4, wherein the colloidal silica is a mixture of globular colloidal silica and chain colloidal silica comprising silica micro-particles connected in series.

8. The polyimide film of claim 1, wherein the metal oxide is silicon oxide.

9. The polyimide film-of claim 1, wherein the metal oxide is prepared from a metal alkoxide compound by a sol-gel method.

10. The polyimide film of claim 1, wherein the polyimide film comprises tetracarboxylic acid units selected from the group consisting of 3,3′,4,4′-biphenyl-tetracarboxylic acid units or a mixture of 3,3′,4,4′-biphenyltetracarboxylic acid units and pyromellitic acid units and diamine units of 4,4′-diaminobenzene or a mixture of 4,4′-diaminobenzene and 4,4′-diaminodiphenyl ether.

11. The polyimide film of claim 1, wherein the polyimide film contains dispersed inorganic particles haying a mean particle size of 1,000 nm or less.

12. The polyimide film of claim 1, wherein the coated particle layer is bonded to the polyimide film at a 90° peel strength of 0.5 N/mm or more.

13. A polyimide film having a metal film comprising a polyimide film having, at least on one surface thereof, a coated particle layer comprising inorganic particles having a mean particle size of 1,000 nm or less which are coated with a metal oxide coverage via an intervening layer comprising a mixture of the same metal oxide as above and polyimide, and a metal film placed on the coated particle layer of the polyimide film.

14. The polyimide film having-a metal film according to claim 13, wherein the inorganic particles comprise colloidal silica.

15. The polyimide film having a metal film according to claim 14, wherein the colloidal silica is globular colloidal silica.

16. The polyimide film having a metal film according to claim 14, wherein the colloidal silica is chain colloidal silica comprising silica micro-particles connected in series.

17. The polyimide film having a metal film according to claim 14, wherein the colloidal silica is a mixture of globular colloidal silica and chain colloidal silica comprising silica micro-particles connected in series.

18. The polyimide film having a metal film according to claim 13, wherein the metal oxide is silicon oxide.

19. The polyimide film having a metal film according to claim 13, wherein the metal oxide is prepared from a metal alkoxide compound by a sol-gel method.

20. The polyimide film having a metal film according to claim 13, wherein the metal film comprises a metal layer formed on the coated particle layer by vapor deposition and a metal layer plated on the coated particle layer.

21. The polyimide film having a metal film according to claim 13, wherein the-metal film comprises copper metal.

22. The polyimide film having a metal film according to claim 13, wherein the polyimide film comprises tetracarboxylic acid units selected from the group consisting of 3,3′,4,4′-biphenyltetracarboxylic acid units and a mixture of 3,3′,4,4′-biphenyltetracarboxylic acid units and pyromellitic acid units and diamine units of 4,4′-diaminobenzene or a mixture of 4,4′-diaminobenzene and 4,4′-diaminodiphenyl ether.

23. The polyimide film having a metal film according to claim 13, wherein the polyimide film contains dispersed inorganic particles having a mean particle size of 1,000 nm or less.

24. The polyimide film having a metal film according to claim 13, wherein the coated particle layer is bonded to the polyimide film at a 90° peel strength of 0.5 N/mm or more.

25. A process for preparing the polyimide film of claim 1, which comprises the steps of:
coating at least one surface of a polyamic acid film containing a polar organic solvent with a dispersion comprising a metal alkoxide-containing aqueous organic solvent and inorganic particles having a-mean particle size of 1,000 nm or less dispersed therein;
drying the coated solution to form a coated layer; and
heating the polyimide film with the coated layer to a temperature of 300° C. or higher.
